(19) United States
(12) Patent Application Publication
(10) Pub. No.: US 2003/0130101 A1
(43) Pub. Date: Jul. 10, 2003

(54) Tool holding structure

(76) Inventor: Yaw-Der Hwang, Taichung (TW)

Correspondence Address: LAW OFFICE OF LIAUH & ASSOC., 4224 WAIALAE AVE, STE 5-388, HONOLULU, HI, 96816

(21) Appl. No.: 10/042,978

(22) Filed: Jan. 7, 2002

(51) Int. Cl. B23Q 3/157

(52) U.S. Cl. 483/59; 483/67; 211/1.53; 211/70.6

(57) ABSTRACT

A tool holding structure comprises a tool tray and a plurality of tool frames, each having a U-shaped fitting piece and a fastening seat. The tool frames are fastened with the tool tray by the fastening seat. The fitting piece is provided with a fitting edge and a plurality of elastic pieces. The tool is held in the tool frame such that the handle of the tool is pressed against by the elastic pieces of the fitting piece of the tool frame.

### FIELD OF THE INVENTION

The present invention relates generally to a tool, and more particularly to a holding structure of the tool.

### BACKGROUND OF THE INVENTION

The numerically-controlled process machine is provided with a computer program to facilitate the selecting of a tool from the tool bank. In light of the design requirements of the upright process machine and the horizontal process machine being different, they are provided with different tool banks to cooperate with the different operations of changing tools. As shown in FIG. 1, a prior art tool bank 1 comprises a tool tray 11 which is provided with a plurality of semicircular holding portions 12, which are in turn provided with a retaining block 13 for holding a tool 2, and with an arresting block 14 to facilitate the holding of the tool 2 on the tool tray 11. In order to locate the tool 2 in the holding portion 12, the holding portion 12 is provided with a groove 15 and a spring 16 disposed in the groove 15 for holding securely the tool 2. When the tool is placed by the process shaft, the tool on the process shaft is capable of spreading the spring 16, so as to enable the tool to be placed in the holding portion 12. The spring 16 is compressed to hold the tool securely. When the main shaft is trying to catch the tool, the tool bank 1 moves out from the side. In the meantime, the spring 16 spreads out. The tool is separated from the tool bank such that the tool is mounted on the process main shaft. The spring 16 is made in a special way such that the spring 16 must be treated in a plurality of processes at additional cost. In addition, the spring 16 has a holding point which is suspended such that the holding point is jutted out of the holding portion 12 and is therefore vulnerable to deformation which is caused by the impact in the midst of tool changing operation. As a result, the holding capacity of the spring 16 is undermined. For the purpose of overcoming the deficiencies described above, a tool tray structure was introduced and disclosed in the Taiwan Patent 86209135. The tool tray structure comprises a tool tray 3, as shown in FIG. 2. The tool tray 3 is of an elastic holding structure and is made of carbon fiber, glass fiber compound or engineering plastic by injection molding. The tool tray 3 has a retaining arm 31 which is provided with a groove 32, so as to make the retaining aim 31 elastic. The tool tray 3 further has a receiving space 33 which is provided at the front end thereof with two projections 34. As the tool is received in the receiving space 33, the tool is located by the projections 34. In light of the tool tray 3 being made integrally of a plastic material, the tool tray 3 is not structurally strong to withstand the impact which is brought about at the time when the tool change is in progress, thereby undermining the precision of the tool tray 3.

As shown in FIG. 3, the Taiwan Pat. Serial No. 87213176 discloses a tool frame 4, which is integrally made of a strong plastic material and is provided at the front end with two claws 41. Located between the claws 41 and a rear end plate 42 is a clamping slot 43. The claws 41 are resilient. The rear end plate 42 is provided with a sunk hole 45 and an arresting block 46. The claws 41 are provided with a fitting edge 47. The tool frame 4 is fastened with a tool tray 5. As a tool 6 is placed, a protruded ring 61 of the tool 6 urges the claws 41 to expand outwards. In the meantime, an annular slot 62 of the tool 6 is fitted with the fitting edge 47 of the tool frame 4. When the tool 6 is completely held by the claws 41, the arresting block 46 of the tool frame 4 is retained in a retaining slot 63 of the tool 6. The tool tray 5 is made by casting. The claws 41 of the tool frame 4 are vulnerable to wear and fatigue. As a result of the prolonged use of the tool frame 4, the claws 41 are unable to hold the tool 6 securely.

### SUMMARY OF THE INVENTION

The primary objective of the present invention is to provide a tool bank with a tool holding structure which is free of the deficiencies of the prior art structures described above.

In keeping with the principle of the present invention, the foregoing objective of the present invention is attained by the tool holding structure comprising a tool frame which is formed of a U-shaped fitting piece and a fastening seat. The tool frame is fastened to a tool tray by the fastening seat. The fitting piece is provided with a fitting edge and a plurality of elastic bodies. The tool is held in the tool frame in such a manner that the handle of the tool is pressed against by the elastic bodies.

The features and the advantages of the present invention will be more readily understood upon a thoughtful deliberation of the following detailed description of the present invention with reference to the accompanying drawings.

### BRIEF DESCRIPTION OF THE DRAWINGS

FIG. 1 shows a schematic view of a tool tray of the prior art.

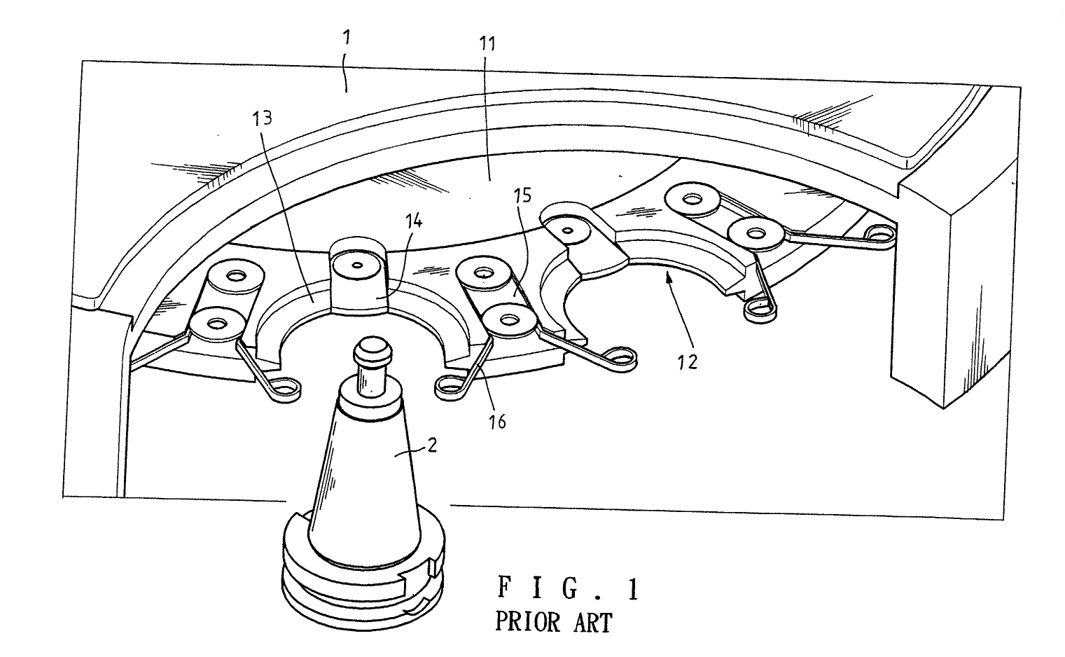

FIG. 2 shows a schematic view of a tool tray of the Taiwan Pat. Serial No. 86209135.

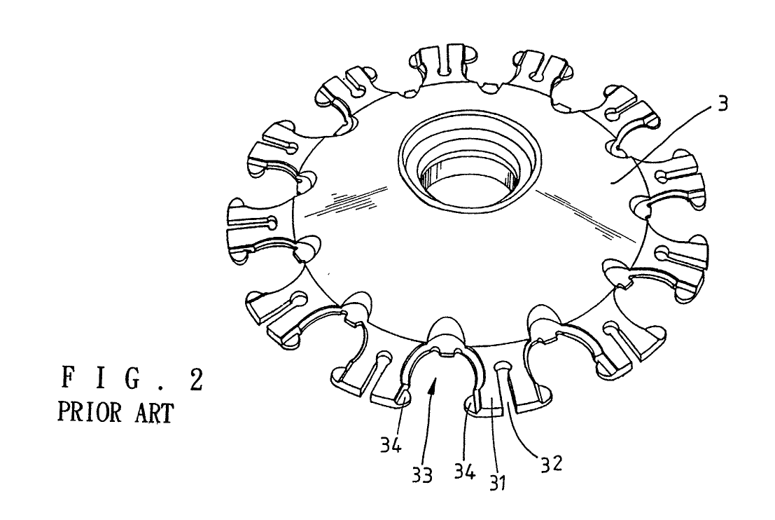

FIG. 3 shows a schematic view of a tool tray of the Taiwan Pat. Serial No. 87213176.

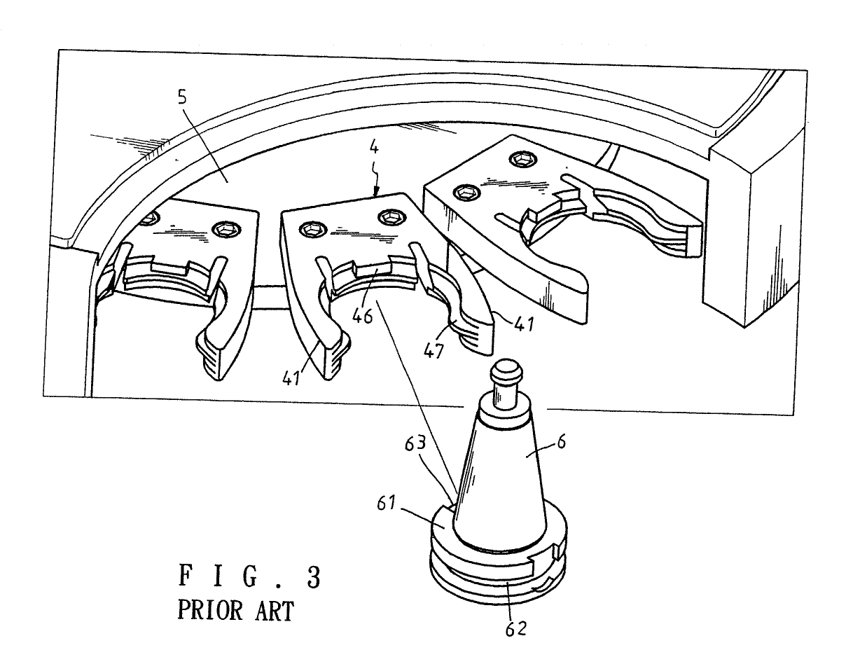

FIG. 4 shows a perspective view of a tool frame of the present invention.

FIG. 5 shows a plan view of the tool frame of the present invention.

FIG. 6 shows a schematic view of the tool frame of the present invention being mounted on a tool tray.

FIG. 7 shows a schematic view of the present invention in action.

FIG. 8 shows a schematic view of the elastic bodies of the present invention in action.

FIG. 9 shows another schematic view of the elastic bodies of the present invention in action.

FIG. 10 shows a schematic view of another preferred embodiment of the present invention.

### DETAILED DESCRIPTION OF THE INVENTION

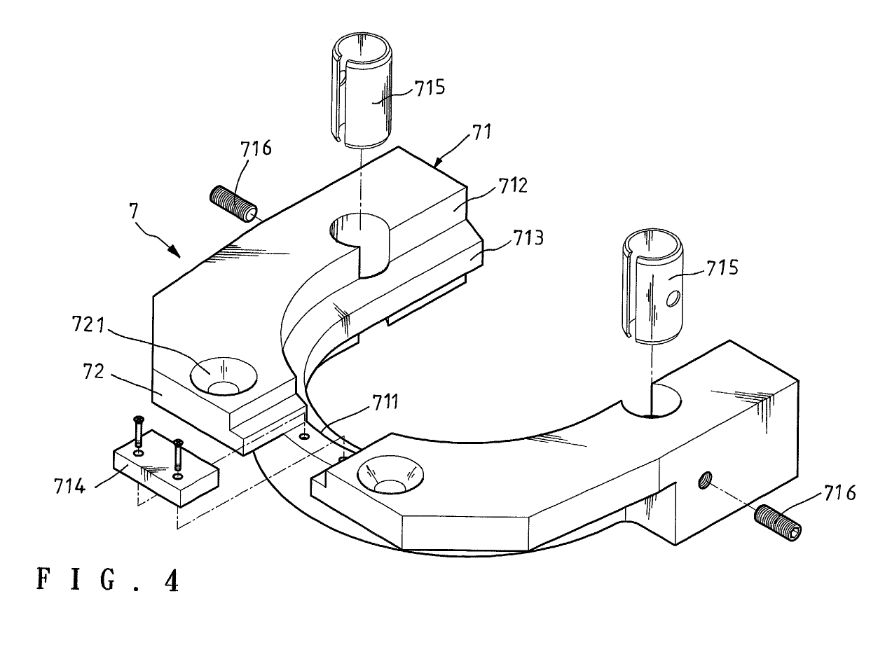

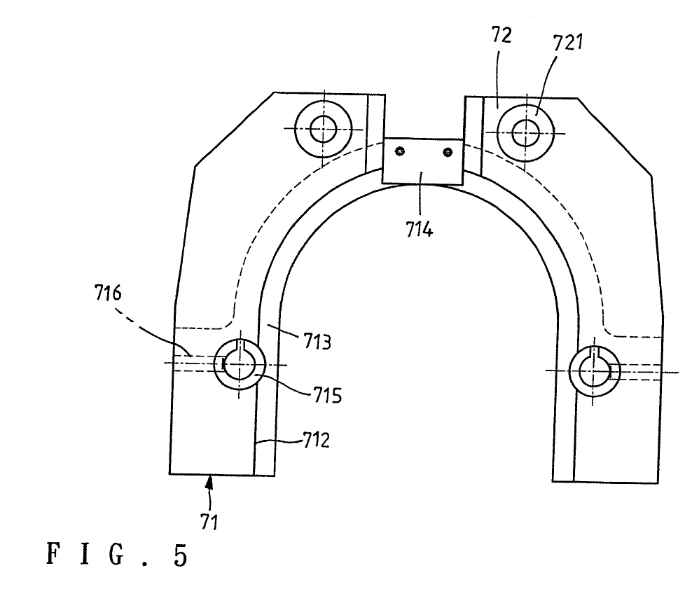

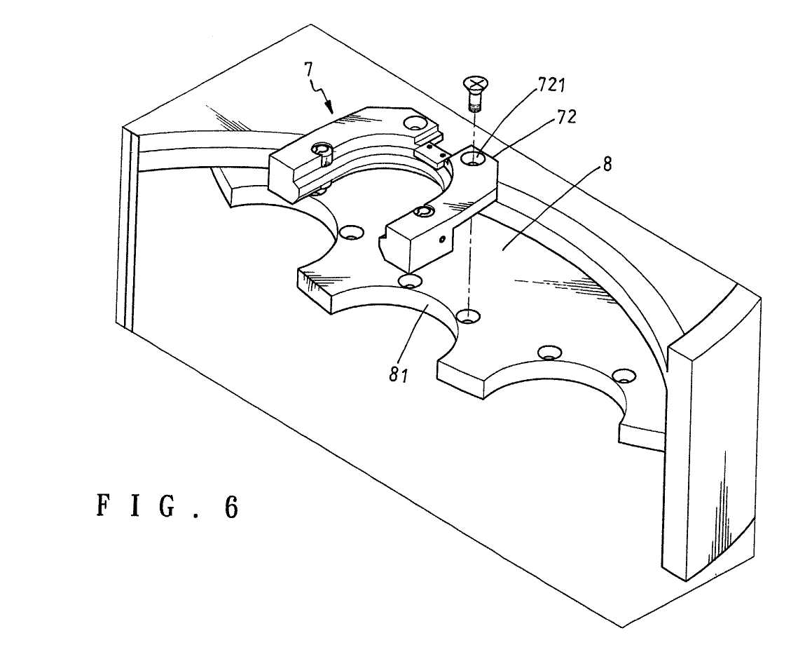

As shown in FIGS. 4-9, a tool frame 7 embodied in the present invention is of a U-shaped construction and is formed of two arms 71, and a fastening portion 72 which is located on a connection portion 711 and is provided with two threaded holes 721 by means of which the tool frame 7 is fastened to a tool tray 8 in conjunction with a plurality of fastening bolts, as illustrated in FIG. 6. The U-shaped tool frame 7 has an open end. The open end and the connection portion 711 are corresponding in inner diameter to a tool handle protruded ring of a tool. The two arms 71 of the U-shaped tool frame 7 have an inner side 712 which is provided with a fitting edge 713. The fitting edge 713 is retained in a tool handle slot of the tool to prevent the fall of the tool from the tool frame 7. The two arms 71 are further provided with an arresting block 714 to prevent the tool handle from turning. The open end of the tool frame 7 is provided with two elastic pieces 715 opposite in location to each other to hold securely the handle of the tool. The elastic pieces 715 are spring pins, each having an opening and a retaining pin 716 for preventing the spring pin 715 from turning or escaping from the tool frame 7.

As shown in FIG. 6, the tool frame 7 is fastened to the tool tray 8 which is provided with a plurality of arcuate slots 81 for receiving the outer side wall of the arms 71 of the tool frame 7.

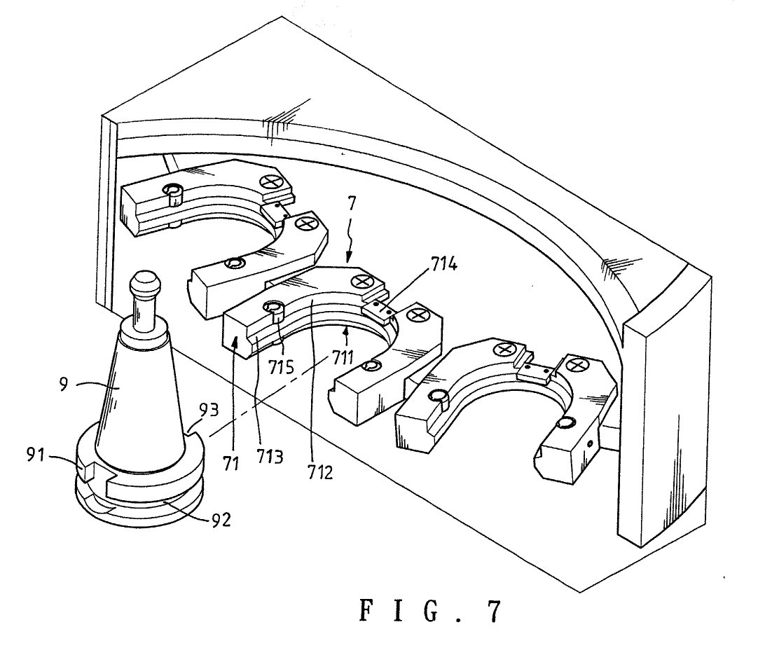

As shown in FIG. 7, a tool handle 9 has a protruded ring 91 and an annular slot 92. The protruded ring 91 is provided with a retaining slot 93. The outer diameter of the protruded ring 91 is corresponding to the diameter of the open end of the tool frame 7 and the inner diameter of the connection portion 711. The annular slot 92 is corresponding to the fitting edge 713 of the tool frame 7. As the tool handle 9 is held in the tool frame 7, the arresting block 714 of the tool frame 7 is retained in the retaining slot 93 of the tool handle 9, so as to prevent the tool handle 9 from turning.

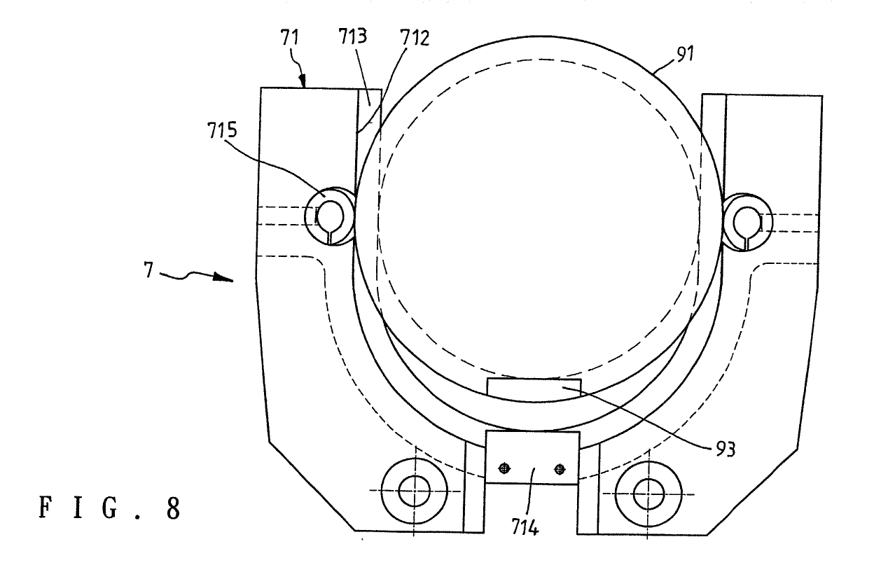

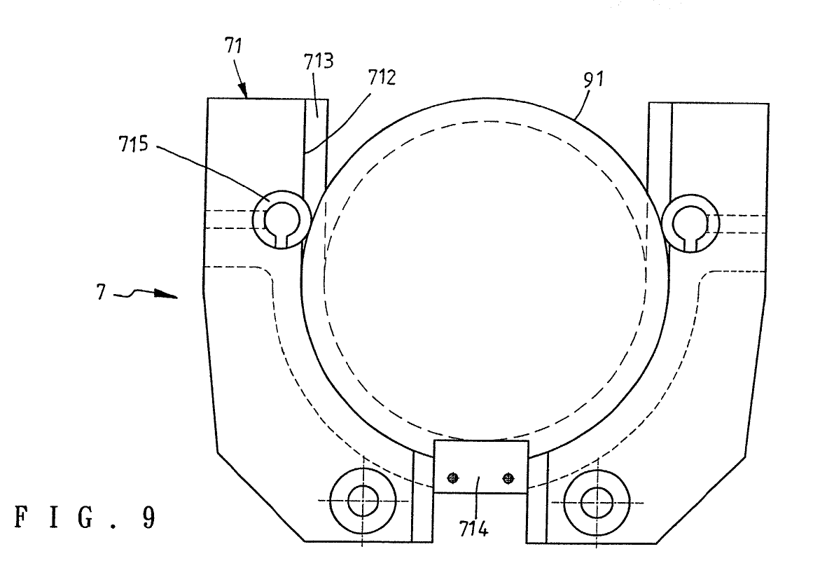

As shown in FIG. 8, the spring pin 715 is jutted out of the inner side wall 712 of the arm 71 of the tool frame 7. When the tool 9 is put into the tool frame 7, the spring pins 715 are pressed against by the protruded ring 91 of the tool 9, thereby causing the spring pins 715 to compress to allow the tool 9 to be put into the tool frame 7. Thereafter, the deformed spring pins 715 recover their original form to press against the protruded ring 91 of the tool 9, as shown in FIG. 9. In light of the spring pins 715 being made of a metal material, the spring pins 715 are resistant to impact and can be used for a prolonged period of time without being vulnerable to wear or fatigue.

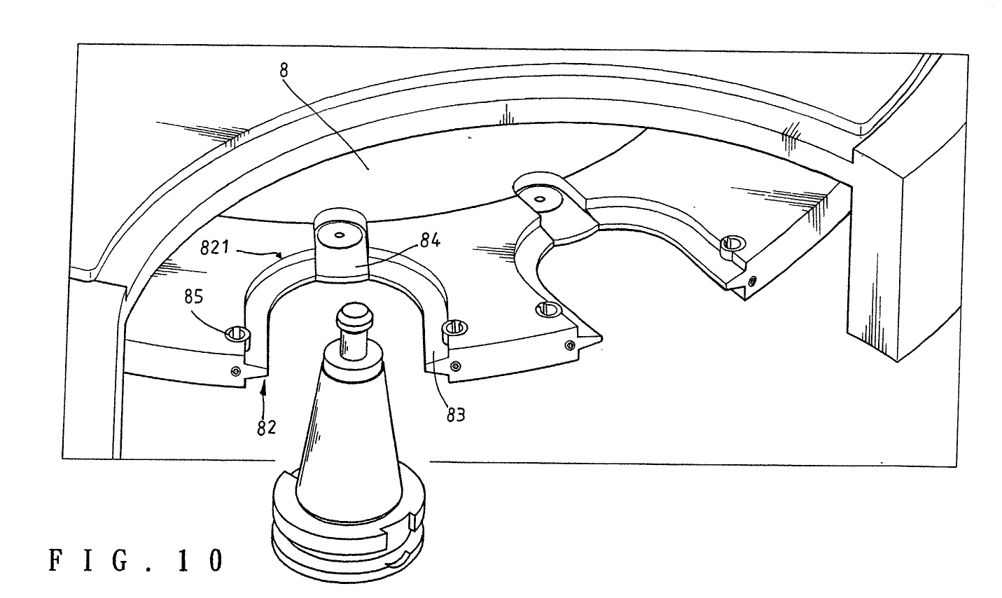

As shown in FIG. 10, the tool tray 8 is provided with a plurality of U-shaped slot 82 which is in turn provided with a fitting edge 83 and an arresting block 84. The U-shaped slot 82 is provided with an open end and a closed end 821. The open end of the slot 82 is provided in proximity thereof with two spring pins 85 for holding the tool.

The embodiments of the present invention described above are to be regarded in all respects as being illustrative and nonrestrictive. Accordingly, the present invention may be embodied in other specific forms without deviating from the spirit thereof. The present invention is therefore to be limited only by the scopes of the following claims.

What is claimed is:

1. A tool holding structure comprising a tool tray which is provided with a plurality of tool frames fastened therewith, said tool frames being of a U-shaped construction and having two arms and a fastening seat, said two arms forming an open end and having in an inner side wall thereof a fitting edge engageable with a fitting slot of a tool handle whereby said two arms are provided in proximity of said open end with an elastic piece capable of being deformed by the tool handle and capable of recovering an original form thereof upon being relieved of by the tool handle.

2. The structure as defined in claim 1, wherein said elastic piece is a spring pin with an opening and an elasticity.

3. The structure as defined in claim 2, wherein said spring pin is provided with a retaining pin for retaining said spring pin such that said spring pin is prevented from turning and from becoming separated from said arms.

4. The structure as defined in claim 1, wherein said open end of said two arms has an inner diameter corresponding to an outer diameter of the tool handle.

5. The structure as defined in claim 1, wherein said tool frames are provided with an arresting block engageable with a retaining slot of the tool handle.

6. The structure as defined in claim 1, wherein said fastening seat is provided with a plurality of threaded holes for fastening said tool frames to said tool tray in conjunction with a plurality of fastening bolts.

7. The structure as defined in claim 1, wherein said tool tray is provided with a plurality of arcuate slots; wherein said tool frames are fastened with said tool tray such that said fastening seat of said tool frames is received in one of said arcuate slots of said tool tray.

8. A tool holding structure comprising a tool tray which is provided with a plurality of U-shaped slots, each having an open end and a fitting edge, said U-shaped slots being provided in proximity of said open end thereof with two elastic pieces opposite in location to each other whereby said elastic pieces are deformed by a tool handle and are capable of recovering an original form thereof upon being relieved of by the tool handle.

9. The structure as defined in claim 8, wherein said elastic pieces are spring pins, each having an opening and an elasticity.

10. The structure as defined in claim 8, said open end of said U-shaped slots has a diameter corresponding to the outer diameter of the tool handle.

11. The structure as defined in claim 8, wherein said said U-shaped slots are provided with an arresting block engageable with the retaining slot of the tool handle.
